(19) United States
(12) Patent Application Publication
(10) Pub. No.: US 2010/0062743 A1
(43) Pub. Date: Mar. 11, 2010

(54) WIRELESS LOCK

(75) Inventor: Mattias Jonsson, Moindal (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON, Stockholm (SE)

(21) Appl. No.: 11/574,001

(22) PCT Filed: Aug. 20, 2004
(86) PCT No.: PCT/SE2004/001220

§ 371 Date: Dec. 17, 2008

(51) Int. Cl. H04M 3/16

(52) U.S. Cl. 455/410

(57) ABSTRACT

The invention provides for a portable device, a system comprising at least two portable devices and a method according to which at least a first portable device and at least a second portable device can be arranged so that said devices have to be located within a short distance from each other if access to the contents in said first device should remain enabled and/or access to the contents in said second device should remain enabled.

### FIELD OF THE INVENTION

The present invention relates to an automatic protection system and to a method of using such a system. In particular, the invention relates to an automatic information protection system having a wireless information-carrier device equipped with an enabling/disabling control function, and a wireless control device for performing wireless communication with said wireless information-carrier device, for performing enabling and disabling functions automatically, and method of use thereof.

### BACKGROUND OF THE INVENTION

Over a period of time there has been continuous development of powerful portable devices. A non exhaustive list of such portable devices are laptops, personal digital assistants (PDA:s), digital notebooks, mobile phones and even land-radios (e.g. walkie-talkies) etc. Such powerful devices are often carrying large amounts of information that has to be protected from access by unauthorized persons. These powerful devices may also comprise computer programs or other applications that has to be protected from being used by unauthorized persons, e.g. applications providing access to bank accounts, databases and/or communication networks or similar.

In this connection it is common to protect the information carrier and its contents by a PIN (Personal Identification Number) or a password or similar that is required during start-up. However, a PIN-code or a password that is entered during start-up does not protect the device once it has become operational. Consequently, there is a risk that an unauthorized person gets hold of an operational device and consequently the information and/or the application(s) therein. This problem can be solved to some extent by using a time-out function that locks the device after a specified time of inactivity. A PIN-code or a password is then required for unlocking the device, much like PIN-coded screen-savers that are frequently used in connection with personal computers.

Hence, a time-out function has the obvious drawback that the device may not yet have been locked when it is accessed by an unauthorized person. In addition, using a PIN-code or similar is not practical or even recommended in all situations. For one thing, entering a PIN-code each time a locked device is to be used can be a source of irritation. More importantly, in some situations entering a PIN-code may cause a serious and harmful delay and it may even be impossible, especially in connection with information-carrier devices used by policemen, firefighters or ambulance personnel or similar. Such personnel are frequently involved in stressful and demanding situations that require measures without delay, and/or where the required measure occupies the hands of the personnel. Entering a PIN-code is hardly recommended in these situations.

Consequently, there is a need for an improved system for protecting the contents, e.g. information and functions, in an information-carrier device and an improved method of using such a system. In particular, there is a need for a system and a method that requires a minimum of user involvement to achieve protection of the information and the functions in an information-carrier device.

### SUMMARY OF THE INVENTION

The invention provides for a first portable device that is adapted to protect the contents of the device if there is no cooperating second portable device within a close range of said first device. This can be achieved by arranging said first device to enable access to its contents substantially the whole time an enabling signal is received, and to disable access to its contents substantially the whole time no enabling signal is received, where an enabling signal is supposed to be transmitted within a short range from a second portable device that can be located within said close range.

The invention also provides for a portable protection system having at least a first portable device and at least a second portable device, which system is arranged to protect the contents of at least said at least first device in the absence of a cooperating second device within a close range of said first at least first device. This can be achieved by arranging said first device to enable access to its contents substantially the whole time an enabling signal is received, and to disable access to its contents substantially the whole time no enabling signal is received; and by arranging said second device to substantially continuously transmit an enabling signal within a short range, which signal is adapted to be received by said first device.

Consequently, it should be clear that a first device and a second device in a protection system according to the present invention can be arranged so that said devices have to be located within a short distance from each other if access to the contents in said first device should remain enabled. In other words, access to the contents in said first device is disabled if the first device and the second device are located too far away from each other. The access may consequence change between enabled and disabled depending on the position of the devices.

Moreover, some embodiments of the protection system may have said first device provided with the additional ability to transmit an enabling signal within a short range and have said second device provided with the additional ability to enable access to its contents substantially the whole time an enabling signal is received, and to disable access to its contents substantially the whole time no enabling signal is received.

Consequently, it should be clear that a first device and a second device in a protection system according to the present invention can be arranged so that the devices have to be located within a short distance from each other if access to the contents in both devices should remain enabled. In other words, access to the contents in both devices is disabled if the devices are located too far away from each other.

Furthermore, the invention provides for a method for protecting the contents in a portable device or portable devices, wherein the general steps are:
enabling access to the contents of at least one of said portable devices substantially the whole time an enabling signal is received by the device; and
disabling access to the contents of said device substantially the whole time no enabling signal is received.

The steps must not necessarily be performed in the suggested order.

### BRIEF DESCRIPTION OF THE DRAWINGS

FIG. 1a shows a person wearing a protected system according to a first embodiment of the invention.

FIG. 1b is a detailed illustration in perspective of the control device shown FIG. 1a.

FIG. 2a shows a protected system according to a second embodiment of the invention.

FIG. 2b is a detailed illustration in perspective of the portable control device shown in FIG. 2a.

FIG. 3 is a schematic drawing of an exemplifying protected system illustrating the basic outline of an embodiment of the invention.

FIG. 4 is a schematic drawing illustrating the conceptual outline of an exemplifying embodiment of a security-unit according to the present invention.

FIG. 5 shows a flowchart illustrating the steps that may be performed by an information-carrier device in the exemplifying system shown in FIG. 3.

FIG. 6 shows a flowchart illustrating the steps that may be performed by a control device in the exemplifying system shown in FIG. 3.

FIG. 7 shows a flowchart illustrating the steps that may be performed by an information-carrier device in the exemplifying system shown in FIG. 3.

FIG. 8 shows a flowchart illustrating the steps that may be performed by a control device in the exemplifying system shown in FIG. 3.

### DETAILED DESCRIPTION OF PREFERRED EMBODIMENTS

The invention will now be described in more detail below with reference to protected systems according to various embodiments of the present invention.

The exemplifying systems may comprise a single information-carrier device and a single control device that are adapted to communicate with each other. However, other embodiments of the invention may refer to systems comprising a single information-carrier device and a plurality of control devices that are adapted to communicate with said single information-carrier device. Other embodiments still may refer to systems comprising a plurality of information-carrier devices and a plurality of control devices, where each control device are adapted to communicate with one or several information-carrier devices.

### A Protected System

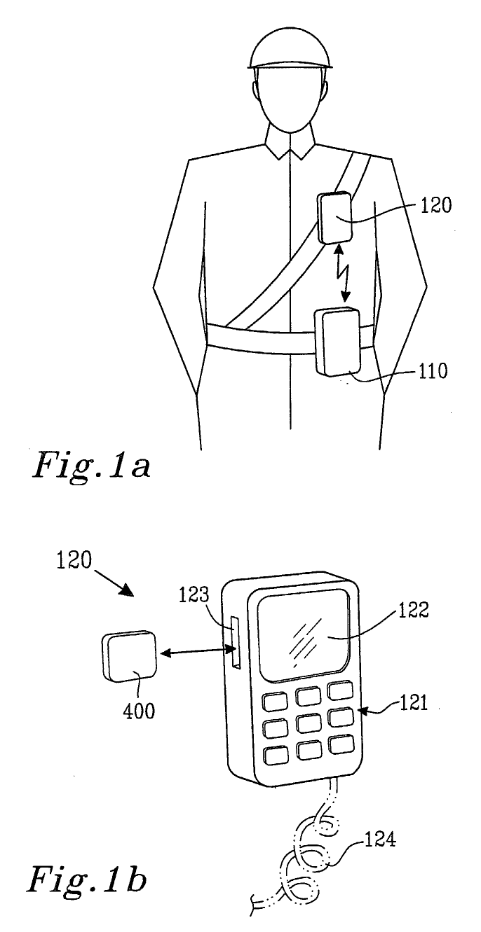

FIG. 1a shows a person wearing a protected system according to a first embodiment of the present invention. The system comprises an information-carrier device 110 that may be attached to a belt on the user, and a control device 120 that may be positioned in a breast pocket or attached to a shoulder belt or similar on said user. The information-carrier device 110 may be a PDA, a digital notebook, a mobile phone, a mobile land-radio or any similar portable device provided with an information storing capability. It is moreover preferred that the information-carrier device 110 is capable of running one or several applications, e.g. capable of running a computer program or similar. The information-carrier device 110 in FIG. 1a is provided with a security-unit 400 (not shown in FIG. 1a) according to an embodiment of the present invention.

FIG. 1b is a detailed illustration in perspective of the control device 120 shown FIG. 1a. The control device 120 in FIG. 1a-1b is a maneuver device comprising a keyboard 121 and a display 122. The maneuver device 120 is adapted for a remote maneuvering of the operational functions of the information-carrier device 110, i.e. for an operational maneuvering of the carrier device 110 without using the controls of the device 110. Typically, only a selected subset of the functions comprised by the information-carrier device 110 can be maneuvered by the maneuvering device 120. These functions may be the most commonly used functions and/or the functions that are the most essential. The maneuver device 120 is comparably small and it can be easily carried by the user in an accessible position for a convenient maneuvering of the comparably bulkier and heavier information-carrier device 110, which can be arranged in a position that is less accessible but more suitable for carrying such loads, e.g. in a backpack arrangement, in a case attached to a belt or similar. It should be added that the maneuver device 120 may comprise its own information carrying capabilities and it may also be capable of running certain applications. The maneuver device 120 may also comprise additional features, such as a digital camera for taking pictures that is transmitted to the information-carrier device 110 or a microphone-loudspeaker combination for a distributed use of the voice communication capability (e.g. a land-radio function) of the information-carrier device 110. The maneuver device 120 in FIG. 1b is—like the information-carrier device 110—provided with a security-unit 400 according to an embodiment of the present invention. In general, a security-unit 400 may be permanently attached to a maneuver device 120 or similar, or it may be entirely or partly exchangeable, as illustrated by the insertion slot 123 and the two-way arrow in FIG. 1b. The maneuver device 120 and the information-carrier device 110 in FIG. 1a-1b are preferably communicating by means of wireless communication. However, the two devices 110, 120 may as a complement communicate via an electric cord 124, e.g. to reduce power consumption.

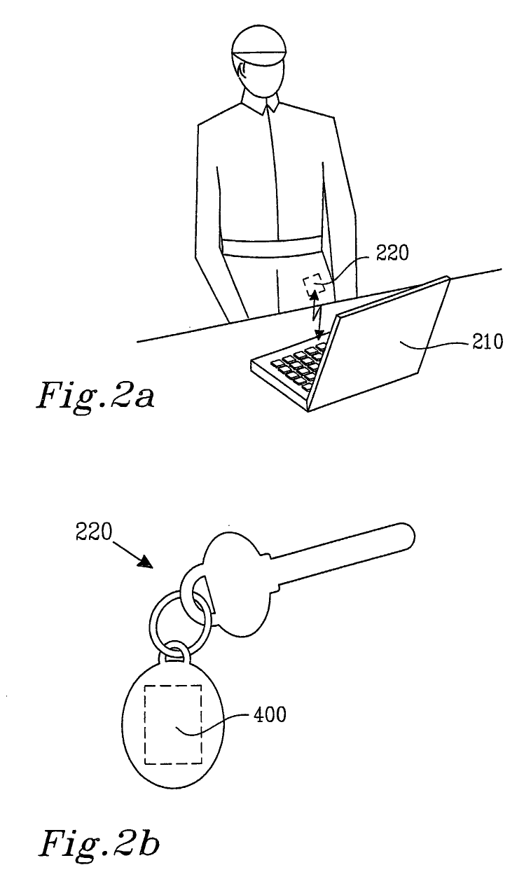

FIG. 2a shows a protected system according to a second embodiment of the invention. The system comprises an information-carrier device 210, e.g. arranged on a table or a desk, and a portable control device 220, e.g. arranged in a pocket of a user. Said information-carrier device 210 may be a laptop, a PDA, a digital notebook or any similar portable device provided with an information storing capability. It is preferred that the portable device 210 is capable of running one or several applications, e.g. capable of running a computer program or similar. The information-carrier device 210 in FIG. 2a is provided with a security-unit 400 (not shown in FIG. 2a) according to an embodiment of the present invention.

FIG. 2b is a detailed illustration in perspective of the portable control device 220 shown in FIG. 2a. The control device in FIG. 2a-2b is a simple device 220 comprising a minimum of components besides a security-unit 400 according to an embodiment of the present invention. The simple control device in FIG. 2a may be incorporated in a key-ring gadget as illustrated in FIG. 2b. The maneuver device 220 and the information-carrier device 210 in FIG. 2a-2b are preferably communicating by means of wireless communication.

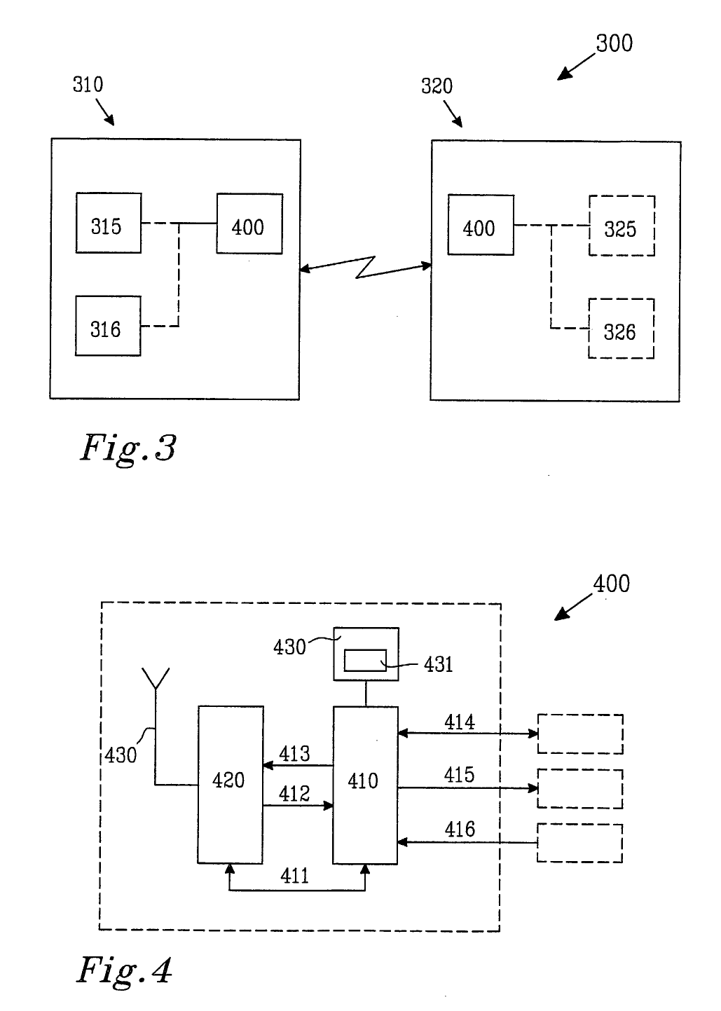

FIG. 3 is a schematic drawing of a protected system 300 illustrating the basic outline of an exemplifying embodiment of the invention. The exemplifying system 300 comprises a portable information-carrier device 310 corresponding to the information-carrier device 110, 210 discussed above. Further, the system 300 comprises a portable control device 320 corresponding to the control device 120, 220 discussed above.

The information-carrier device 310 in FIG. 3 comprises a security-unit 400 and at least one information-storing unit 315 that is protected by said security-unit 400. The information-storing unit 315 may for example be a Compact Disk (CD), a Digital Video Disc (DVD), a Hard Disk (HD), a Random Access Memory (RAM), a Read-Only Memory (ROM), a Programmable Read-Only Memory (PROM), an Erasable Programmable Read-Only Memory (EPROM), Electronically Erasable Programmable Read Only Memory (EEPROM), Flash-Memory, a memory card comprising a flash memory or any similar unit or device. The information-carrier device 310 in FIG. 3 may also be provided with one or several applications 316 that is protected by the security-unit 400, e.g. provided with access to the functions of a computer program in the case of a laptop, or provided with access to the functions of a radio communication system in the case of a mobile land-radio. The information-storing unit(s) 315 and the possible application(s) 316 may be communicating with each other and/or communicate with the security-unit 400, as illustrated by the dashed lines in FIG. 3.

The control device 320 in FIG. 3 comprises—like the information-carrier device 310—a security-unit 400 according to an embodiment of the invention. The control device 320 may also be provided with at least one information-storing unit 325 that is protected by said security-unit 400. The information-storing unit 325 may for example be; CD, DVD, HD, RAM, ROM, PROM, EPROM, EEPROM, Flash-Memory a memory card comprising a flash memory or any similar unit or device. The control device 320 in FIG. 3 may also be provided with one or several applications 326 that is protected by the security-unit 400, e.g. provided with access to a digital voice recording/playing function or to a digital picture recording/displaying function or any other function or application, such as an activation function through biometric recognition (e.g. a fingerprint recognition function). The information-storing unit(s) 325 and the application(s) 326 may be communicating with each other and/or communicate with the security-unit 400, as illustrated by the dashed lines in FIG. 3.

The information-carrier device 310 and the control device 320 in FIG. 3 are preferably communicating by means of wireless communication, which is illustrated by a bidirectional arrow between the carrier device 310 and the control device 320 in FIG. 3. The communication may be performed by using substantially any known wireless signals, such as electromagnetic waves including radio, microwave, or infrared signals or acoustic waves such as ultrasound. It should also be added that some embodiments of the invention may be directed to portable systems that have other objects than information that has to be protected.

### The Security-Unit

FIG. 4 is a schematic drawing illustrating the basic outline of an exemplifying embodiment of a security-unit 400 according to the present invention. The security-unit 400 may be powered by its own battery (not shown) or by the power source of the device that is provided with a security-unit 400.

The security-unit 400 in FIG. 4 is provided with a controller 410 that controls the overall operation of the security-unit 400. The controller 410 may include a microprocessor and a ROM for storing an operation controlling program of the protection device 410 and a RAM for temporarily storing data generated during program performance.

The security-unit 400 is further provided with a memory 430 for storing at least one identification code 431, which code can be used in connection with the protection of information and/or application(s) or similar in a device 310, 320 that has been provided with a security-unit 400. The memory 430 may be a CD, a DVD, a HD, a RAM, a ROM, a PROM, an EPROM, an EEPROM, a Flash-Memory, a memory card comprising a flash memory or any similar unit or device. The memory 430 may be integrated in the security-unit 400 or in the controller 410, or it may be a separate unit that is communicating with the security-unit 400 or the controller 410, e.g. communicating by a circuit line or some other connector. The memory 430 may even be an exchangeable unit, as illustrated by the exchangeable security-unit 400 and the insertion slot 123 in FIG. 1b, in which the illustrated unit 400 may represent the entire security-unit 400 or just a part of it, e.g. only the memory 430. The identification code 431 and other information stored in the memory 430 may furthermore be protected by a physical and/or logical protection or similar that is arranged to erase the stored contents of the memory 430 if the protection is broken or otherwise penetrated or tampered with.

The security-unit 400 is moreover provided with a transceiver 420 for transmitting and receiving wireless signals within a short range, e.g. less than 10 meters, preferably less than 5 meters and most preferably less than 2 meters. The transceiver 420 is preferably controlled by the controller 410 via a control bus 411. The controller 410 may e.g. command the transceiver 420 to switch from a transmitting to a receiving status or vice-versa. The controller 410 may also command the transceiver 420 to use a certain receiving or transmitting frequency, or command the transceiver 420 to only transmit/receive during certain intervals or otherwise decide the transmit-receive cycle.

The controller 410 and the transceiver 420 in FIG. 4 are connected via an output connection 413 through which the controller 410 can supply the transceiver 420 with data to be transmitted. The data to be transmitted is converted by the transceiver 420 to a wireless transmission signal, for example converted from a digital signal to an analogue signal and then mixed, filtered and amplified in a well known manner used for transmitting radio signals. The wireless transmission signal is then transmitted via an antenna 430 connected to the transceiver 420, or similar arrangement adapted to transmit a wireless signal, for example a light emitting diode in the case of an infrared signal or a loudspeaker in the case of an ultrasound signal.

The controller 410 and the transceiver 420 in FIG. 4 are moreover connected via an input connection 412 through which the transceiver 420 can supply the controller 410 with data that is received by the antenna 430 or similar arrangement adapted to receive a wireless signal, e.g. a light sensitive photodiode in the case of an infrared signal or a microphone in the case of an ultrasound signal. A received signal is converted by the transceiver 420 to a data signal, for example amplified, filtered, mixed and finally converted from an analogue signal to a digital signal in a well known manner used for receiving radio signals.

The exemplifying security-unit 400 in FIG. 4 is furthermore provided with the ability to communicate with the information-storing unit(s) 315, 325 and/or the application(s) 316, 326 or similar in a device 310, 320 that is provided with said security-unit 400. This has been illustrated in FIG. 4 by connections, such as an output connection 416, an input connection 415 and an input/output connection 414 that are adapted to connect the controller 410 the security-unit 400 to the information-storing unit(s) 315, 325 and/or the application(s) 316, 326. The information-storing unit(s), the application(s) 316, 326 or similar has been schematically illustrated by rectangles having dashed lines. However, FIG. 4 does not imply that a security-unit 400 according to the present invention is provided with three (3) connections or communication channels. On the contrary, some security-units 400 may have one communication channel or similar, whereas other security-units 400 may have several channels. Moreover, a communication channel may be any suitable channel, e.g. a serial or parallel data-bus or similar.

It should be added to the discussion above that some embodiments of the invention may have the identification code 431 transferred from the information carrier device 310 to the security-unit 400 in the control device 320 or the other way around, e.g. by using the controller 410 and the transceiver in said security-units 400. The devices 310, 320 will then be a pair that can cooperate with each other according to the present invention. An advantage with this procedure is that any two devices can be set up as a pair by simply transferring the identification code from one of the devises to the other. Consequently, the devices are not tied to each other by identification codes that are hard to change. A transfer of an identification code is preferably preceded by the entering of a PIN-code or some other authorization procedure that prohibits unauthorized persons to reinitiate two devices, e.g. reinitiate two stolen devices that comprise different identification codes.

It should also be added to the discussion above that some embodiment of the invention may have a security-unit 400 arranged as one single unit, e.g. arranged as an integrated circuit, or as discrete components on a circuit board (e.g. a PCMCIA-card) or in some other module or similar. However, the invention is not limited to security-units that are embodied as a single unit. On the contrary, the illustration in FIG. 4 merely indicates that a preferred security-unit according to the present invention may utilize a controller, a transceiver and a memory or similar, whereas the precise location and/or implementation of such components may vary in different embodiments of the invention.

If, for example, the device to be provided with a security-device is a portable laptop or a mobile phone or similar, then it may be possible to utilize a built-in WLAN-device or a built-in Bluetooth-device to fulfill the tasks of the transceiver 420 in the security-unit 400 of FIG. 4. It may also be possible to use the processing power of said laptop or mobile phone to fulfill the tasks of the control device 410 in the security-unit 400 of FIG. 4. Moreover, the memory 430 in the security-unit 400 of FIG. 4 may be the ordinary memory of said laptop or mobile phone. Even though a laptop and a mobile phone are given as examples the built-in functions of a device may in general be arranged to fully or partly participate in the protection of the contents of the device in question when appropriate according to the present invention.

### The Operation of a Protected System

The attention is again directed to the exemplifying system 300 in FIG. 3. As previously explained, the system 300 comprises an information-carrier device 310 provided with a security-unit 400. The system 300 also comprises a control device 320 that is likewise provided with a security-unit 400. The security-unit 400 in the information-carrier 310 is arranged to protect the contents of the carrier 310. The security-unit 400 in the control device 320 may likewise be arranged to protect the possible contents in the device 320.

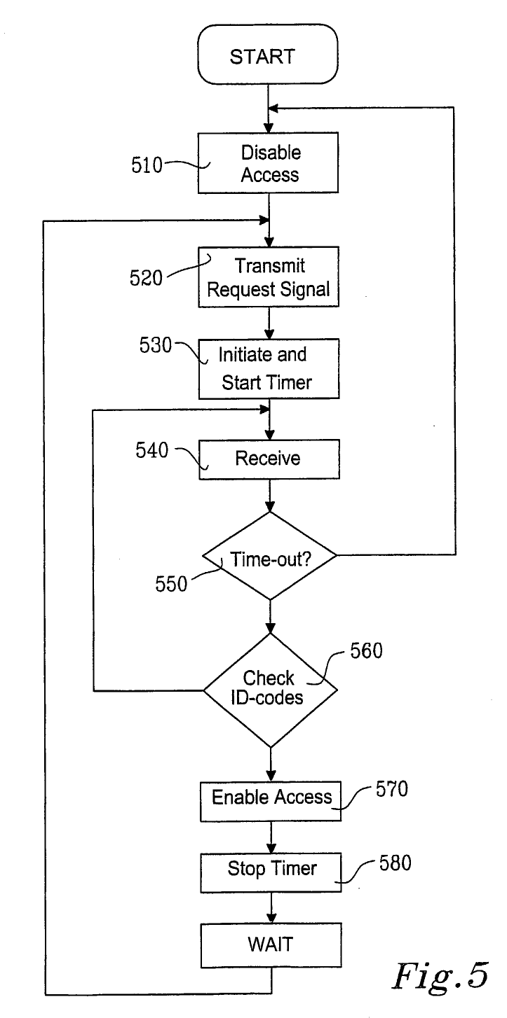

Preferred methods of operating the exemplifying system 300 in FIG. 3 will now be explained with reference to the flowcharts in FIG. 5-8.

### A First Embodiment

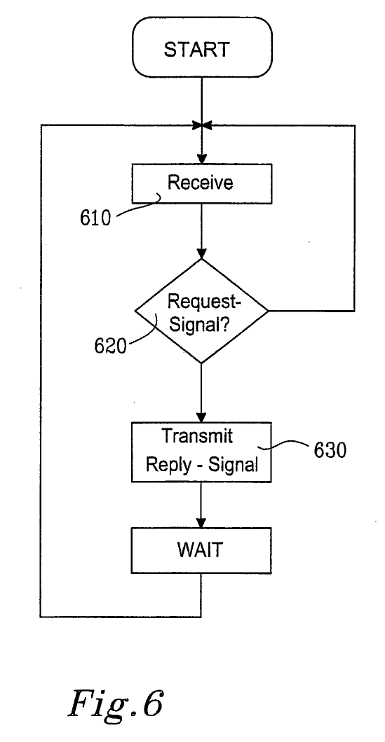

The flowcharts in FIG. 5-6 illustrate how the exemplifying system 300 in FIG. 3 can be operated according to a first embodiment of the present invention.

According to a first step 510 in the flowchart of FIG. 5 the security-unit 400 in the information-carrier device 310 is disabling access to the information and/or application(s) in the carrier device 310. A disabling signal may e.g. be provided from the controller 410 via the output connection 415 to the information-storing unit(s) 315 and/or application(s) in the carrier device 310.

According to a second step 520 in the flowchart of FIG. 5 the security-unit 400 in the information-carrier device 310 is preferably transmitting an intermittent wireless request-signal, i.e. transmitting a request-signal during predetermined intervals. In general, transmitting or receiving is preferably achieved by the controller 410 commanding the transceiver 420 to transmit or receive.

A timer is then initiated and started by the controller 410 in a third step 530. The timer may e.g. be implemented as a counter, which can be initiated with a value that is decreased by a countdown function when the timer is running. The duration of a complete countdown may e.g. depend on the start value and the countdown rate.

The timer start in step 530 is followed by a fourth step 540 wherein the controller 410 commands the transceiver 420 to receive a possible enabling reply-signal. If a signal is received it will be converted by the transceiver 420 and supplied to the controller 410 via the input connector 412. The controller 410 then processes the received signal to investigate if it contains an identification code 431. If a possible received identification code 431 is encoded it is preferably decoded by the controller 410 using the inverse function ƒ⁻¹(id,count) of the encoding function ƒ(id,count), wherein it is preferred that “id” is the received encoded identification code 431 and “count” is a clock value that is continuously updated in the security-unit 400 of the information-carrier device 310. It is moreover preferred that the “count” clock value in an encoding control device(s) 320 is synchronized with the “count” clock value in the information-carrier device 310.

The receiving activity in step 540 is followed by a fifth step 550, wherein a check of the countdown status of the timer is preformed. If the timer has reached the end of the countdown, then the security-unit 400 in the information-carrier device 310 will once again disable access to the information and/or application(s) in the carrier device 310 according to step 510, whereby the operation will proceed to step 520 as previously described.

However, if the timer has not reached the end of the countdown a possibly received and possibly decoded identification code will be compared in a subsequent sixth step 560 with the identification code 431 stored in the memory 430 of the security-unit 400. If a received identification code and the stored identification code is not matching (e.g. are not identical), or if no identification code can be obtained from the received reply-signal, or if no reply-signal has been received, which e.g. will occur if no control device 320 is present within the range of the transmitted request-signal; then the controller 410 in the security-unit 400 of the information-carrier 310 will once again command the transceiver 420 to receive a possible enabling reply-signal according to step 540.

However, if a received identification code and the stored identification code 431 really do match (e.g. are identical); then the security-unit 400 will enable access to information and/or application(s) in the information-carrier device 310 according to a seventh step 570. An enabling signal may for example be provided from the security-unit 400 via the output connection 415 to the information-storing unit(s) 315 and/or the application(s) in the carrier device 310.

The enabling in step 570 is followed by a stop of the timer according to an eight step 580, which stop may be preformed by the controller 410 in the security-unit 400. Said security-unit 400 may then wait a predetermined time before it transmits another request-signal according to step 520. It preferably waits less than a minute, more preferably less than 10 seconds and most preferably less than a few seconds.

Said enabling in step 570 may additionally or alternatively include a possible decryption of encrypted information that is stored in an information-storing unit 315 of the carrier device 310, e.g. by using the inverse function ƒ⁻¹(id,data) of the encryption function ƒ(id,data) that was originally used to encrypt said stored information, wherein “id” represents the identification code 341 of the information-carrier device 310 and “data” represents the stored encrypted information. Said information may e.g. be exchanged between the controller 410 and an information-storing unit 315 via the bi-directional input/output connection 414. The enabling may in similar way include a decryption of encrypted data that is received by the controller 410 from the transceiver 420 of the carrier device 310, e.g. by using the inverse function ƒ⁻¹(id,data) of the encryption function ƒ(id,data) that was originally used to encrypt said received data, wherein “id” represents the identification code 341 stored in the memory 340 of the information-carrier device 310 and “data” represents the received encrypted data.

So far, the operational steps performed by an information carrier device 310 in a system 300 have been described with reference to the flowchart in FIG. 5. The attention will now be directed to the flowchart in FIG. 6, showing an example of the steps that can be performed by a control device 320 in a system 300.

The first step 610 of the flowchart in FIG. 6 is to receive a possible request-signal, which may be accomplished by the controller 410 in the security-unit 400 of the control device 320 commanding the transceiver 420 to receive. If a signal is received it will be converted by the transceiver 420 and supplied to the controller 410 via the input connector 412.

Following the receiving step 610 the controller 410 will process a received signal in a second step 620 to investigate if the signal is a request-signal. If the received signal is not a request-signal, or if no signal has been received at all the security-unit 400 will again listen to a possible transmission of a request-signal according to step 610.

However, if a request-signal is actually received then the controller 410 commands the transceiver 420 to transmit a reply-signal in a third step 630. It is then preferred that said reply-signal includes the identification code 431 stored in the memory 430 of the security-unit 400. It is also preferred that the identification-code is encoded by the controller 410 prior to a transmission, e.g. by using a function ƒ(id,count) as mentioned above, where “id” is the identification code 431 and “count” is a clock value that is continuously updated in the security-unit 400 of the control device 320. The encoded identification code 431 is preferably supplied by the controller 410 to the transceiver 420 via the output connection 413, whereupon the controller 410 commands the transceiver 420 to transmit a reply-signal including the possible encoded identification code 431. The security-unit 400 may then wait a predetermined time before it again listens to a possible transmission of a wireless request-signal according to step 610. It preferably waits less than a minute, more preferably less than 10 seconds and most preferably less than a few seconds.

Consequently, it should be clear from the discussion above and from the flowcharts in FIG. 5-6 that an information-carrier device 310 and a control device 320 in an embodiment of the system of FIG. 3 can be arranged so that said devices 310, 320 have to be located within a short distance from each other to create a situation wherein the information and/or the application(s) in the information-carrier device 310 remain enabled, i.e. accessible. Conversely, the access to information and/or application(s) in the information-carrier device 310 is disabled if the information-carrier device 310 and the control device 320 are located too far away from each other for a certain period. The distance may e.g. be no more than 10 meters, preferably no more than 5 meters and most preferably no more than 2 meters, and the time period may be no more than a minute and preferably no more than 10 seconds and most preferably no more than a few seconds.

In the above description of the operation of the exemplifying system 300 in FIG. 3 it has been assumed that the information-carrier device 310 transmits a request-signal whereas the control device 320 can respond to said request-signal by transmitting a reply-signal if the control device 320 is within the range of the transmitted request-signal. However, the other way around is also possible, i.e. that the control device 320 is arranged to transmit a request-signal, whereas the carrier device 310 is adapted to respond to a received request-signal.

An additional comment should also be made regarding the “wait” step that follows step 580 in FIG. 5 and the wait step that follows step 630 in FIG. 6. These “wait” steps can be omitted in certain embodiments. However, the “wait” step in FIG. 5 can be a random delay or similar, which will reduce the risk that two transmitting devices transmit a request-signal at the same time in a multi-device environment. The “wait” step in FIG. 6 may alternatively or additionally be a random delay or similar, which will reduce the risk that two receiving devices receive at the same time and subsequently transmit a reply-signal at the same time in a multi-device environment.

### A Second Embodiment

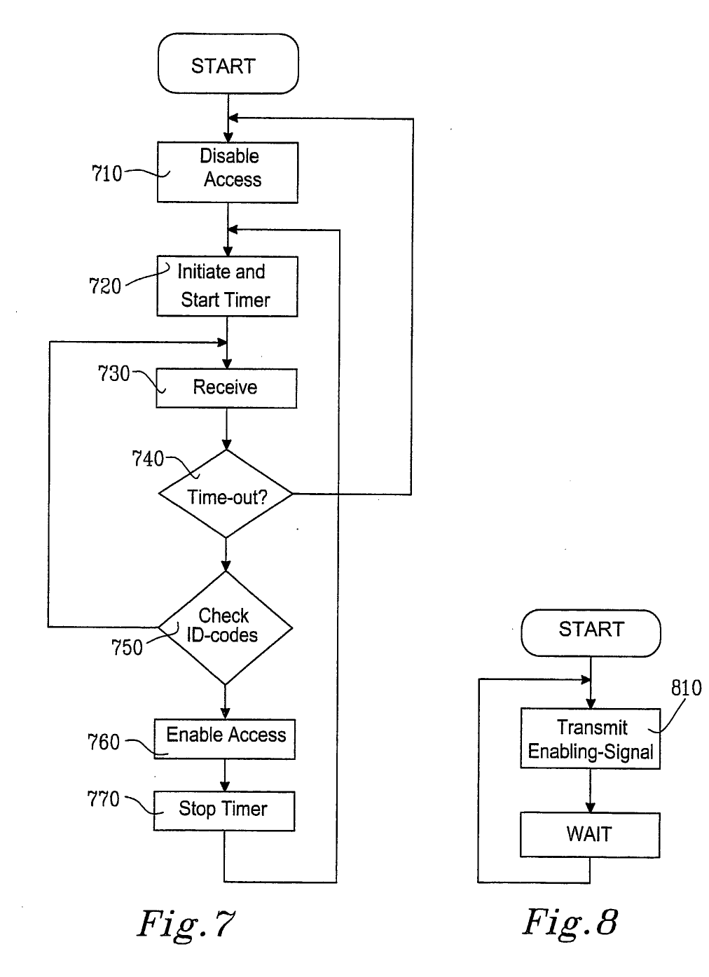

The flowcharts in FIG. 7-8 show how the exemplifying system 300 in FIG. 3 can be operated according to a second embodiment of the present invention.

According to a first step 710 in the flowchart of FIG. 7 the security-unit 400 in the information-carrier device 310 is disabling access to the information and/or application(s) in the carrier device 310 in a similar or identical way as previously described in connection with step 510 in FIG. 5.

A timer is then initiated and started in a second step 720 in a similar or identical way as previously described in connection with step 520 in FIG. 5.

The initiation and start of the timer in step 720 is then followed by a third step 730 wherein the controller 410 commands the transceiver 420 to receive a possible enabling signal. If a signal is received it will be converted by the transceiver 420 and supplied to the controller 410 via the input connector 412. The controller 410 then processes the received signal to investigate if it contains an identification code 431. If a possible received identification code 431 is encoded it is preferably decoded by the controller 410 using the inverse function ƒ⁻¹(id,count) of the encoding function ƒ(id,count), wherein it is preferred that “id” is the received encoded identification code 431 and “count” is a clock value that is continuously updated in the security-unit 400 of the information-carrier device 310. It is moreover preferred that the “count” clock value in an encoding control device(s) 320 is synchronized with the “count” clock value in the information-carrier device 310.

The receiving activity in step 730 is followed by a fourth step 740, wherein a check of the countdown status of the timer is preformed. If the timer has reached the end of the countdown, then the security-unit 400 in the information-carrier device 310 will once again disable access to the information and/or application(s) in the carrier device 310 according to step 710, whereby the operation will proceed to step 720 as previously described.

However, if the timer has not reached the end of the countdown a possibly received and possibly decoded identification code will be compared in a subsequent fifth step 750 with the identification code 431 stored in the memory 430 of the security-unit 400. If a received identification code and the stored identification code is not matching (e.g. are not identical), or if no identification code can be obtained from the received enabling signal, or if no enabling signal has been received, which e.g. will occur if no control device 320 is present within the range of the transmitted request-signal; then the controller 410 in the security-unit 400 of the information-carrier 310 will once again command the transceiver 420 to receive a possible enabling signal according to step 730.

However, if a received identification code and the stored identification code 431 really do match (e.g. are identical); then the security-unit 400 will enable access to information and/or application(s) in the information-carrier device 310 according to a sixth step 760. An enabling signal may for example be provided from the security-unit 400 via the output connection 415 to the information-storing unit(s) 315 and/or the application(s) in the carrier device 310.

The enabling in step 760 is followed by a stop of the timer according to a seventh step 770, which stop may be preformed by the controller 410 in the security-unit 400. Said security-unit 400 then once again initiates and starts the timer according to step 710.

The steps performed by an information carrier device 310 in a system 300 have been described above with reference to the flowchart in FIG. 7. The attention will now be directed to the flowchart in FIG. 8, showing an example of the steps that can be performed by a control device 320 in a system 300.

According to a first step 810 of the flowchart in FIG. 8 the control device 320 is transmitting a signal within a short range, which signal preferably includes the identification code 431 stored in the memory 430 of the security-unit 400 in the control device 320. To save battery power the transmission may be a burst having a short duration. The security-unit 400 may then wait for a predetermined time before it transmits another signal. It preferably waits less than a minute, more preferably less than 10 seconds and most preferably less than a few seconds.

Again it should be clear from the above and from the flowcharts in FIG. 7-8 that an information-carrier device 310 and a control device 320 in an exemplifying system 300 can be arranged so that said devices 310, 320 have to be located within a short distance from each other to create a situation wherein the information and/or the application(s) in the information-carrier device 310 remains accessible.

The operation of the exemplifying system 300 in FIG. 3 has been described with reference to FIG. 7-8 under the assuming that the information-carrier device 310 is adapted to receive an enabling signal and that the control device 320 is arranged to transmit an enabling signal. However, the other way around is also possible, i.e. that the control device 320 is adapted to receive an enabling signal, whereas the carrier device 310 is arranged to transmit an enabling signal.

### Further Embodiments

The exemplifying system 300 in FIG. 3 may be operated according to a third embodiment of the present invention wherein both the information-carrier device 310 and the control device 320 are arranged to transmit a signal as well as adapted to receive a signal, e.g. transmit and receive as previously described with reference to FIG. 5-6, or transmit and receive as previously described with reference to FIG. 7-8.

This may be achieved by running the procedures in FIG. 5 and FIG. 6 as two consecutive procedures in a single security-unit 400. In other words, a device 310, 320 may first transmit a request-signal and then receive a possible enabling reply-signal, as previously described with reference to FIG. 5. The same device 310, 320 may then turn to receiving a possible request-signal and then transmit an enabling reply-signal, as previously described with reference to FIG. 6.

Alternative, this may be achieved by running the procedures in FIG. 7 and FIG. 8 as two consecutive procedures in a single security-unit 400. In other words, a device 310, 320 may first receive a possible enabling signal as previously described with reference to FIG. 7. The same device 310, 320 may then turn to transmitting an enabling signal as previously described with reference to FIG. 8.

The above may be achieved by a time sharing (multiplexing) or a similar use of the resources in the security-unit 400.

Another alternative may be to double the resources in a security-unit 400, which implies that the procedure in FIG. 5 and the procedure in FIG. 6 or the procedure in FIG. 7 and the procedure in FIG. 8 may be running wholly or partly simultaneous.

Consequently, it should be clear that an information-carrier device 310 a the control device 320 in the exemplifying system of FIG. 3 can be arranged so that said devices 310, 320 have to be located within a short distance from each other to create a situation wherein the information and/or the application(s) in both devices 310, 320 remain accessible. In other words, access to information and/or application(s) in both devices 310, 320 can be disabled more or less simultaneously if the devices 310, 320 are located too far away from each other for a certain period. The distance may e.g. be no more than 10 meters, preferably no more than 5 meters and most preferably no more than 2 meters, and the time period may be no more than a minute and preferably no more than 10 seconds and most preferably no more than a few seconds.

While the above description comprises exemplifying embodiments of the present invention, it will be appreciated that the invention is susceptible to modification, variation and change without departing from the proper scope or fair meaning of the accompanying claims.

### REFERENCE SIGNS

110 Information-carrier device
120 Control Device/Maneuver Device
121 Keyboard
122 Display
123 Insertion Slot
124 Electric Cord
210 Information-carrier device
220 Control Device
300 Protected System (Schematic)
310 Information-carrier device
315 Information-storing unit
316 Application
320 Control Device
325 Information-storing unit
326 Protected Application
400 Security-unit
410 Controller
411 Control Bus
412 Output Connection
413 Input Connection
414 Input/Output Connection
415 Output Connection
416 Input Connection
420 Wireless Transceiver
430 Memory
431 Identification Code (ID-code)

1-30. (canceled)

31. A portable electronic device, comprising:
a memory for storing data;
wherein said device is operative to enable access to said data when an enabling external signal is received; and,
wherein said device is operative to disable access to said data when no enabling external signal is received.

32. A portable electronic device according to claim 31, wherein said device is operative to transmit a request-signal within a short range and adapted to receive an enabling reply-signal as a response to said request-signal.

33. A portable electronic device according to claim 31, wherein said device is operative to transmit an enabling signal within a short range.

34. A portable electronic device according to claim 31, wherein said device is operative to receive a request-signal and to transmit an enabling reply-signal within a short range as a response to said request-signal.

35. A portable electronic device according to claim 31, wherein said data comprises information or at least one application, or information and at least one application.

36. A portable electronic device according to claim 31, wherein said device is operative to enable access to said data after receiving an enabling signal or an enabling reply-signal that comprises an identification code that matches an identification code stored in said device.

37. A portable electronic device according to claim 36, wherein said identification code is encoded.

38. A portable electronic device according to claim 36, wherein said device is operative to decode a received identification code that is encoded by a function ƒ(id, count) by using an inverse function ƒ⁻¹(id, count), wherein “id” is the received encoded identification code and “count” is a value that is continuously and synchronously updated in the transmitting and the receiving device.

39. A portable electronic device according to claim 36, wherein said identification code is stored in the device or stored in a security-unit that is adapted to be attached to the device.

40. A portable electronic system adapted for the protection of stored data, comprising:
at least first and second portable devices;
wherein said first device is operative to enable access to its stored data after an enabling signal is received, and to disable access to its stored data when no enabling signal is received; and,
wherein said second device is operative to substantially continuously transmit an enabling signal within a short range, which signal is adapted to be received by said first device.

41. A portable electronic system according to claim 40, wherein:
said first device is operative to substantially continuously transmit a request-signal within a short range and adapted to receive an enabling reply-signal as a response to said request-signal; and,
wherein said second device is adapted to transmit an enabling reply-signal within a short range as a response to said request-signal, which reply-signal is adapted to be received by said first device.

42. A portable electronic system according to claim 40, wherein:
said first device is further operative to substantially continuously transmit an enabling signal within a short range, which enabling signal is adapted to be received by said second device; and,
said second device is further operative to enable access to its stored data substantially the whole time said enabling signal is received, and to disable access to its stored data substantially the whole time no enabling signal is received.

43. A portable electronic system according to claim 40, wherein:
said second device is further operative to substantially continuously transmit a request-signal within a short range, to enable access to its contents substantially the whole time an enabling reply-signal is received, and to disable access to its stored data substantially the whole time no enabling reply-signal is received; and,
said first device is further operative to transmit said enabling reply-signal within a short range as a response to said request-signal.

44. A portable electronic system according to claim 40, wherein the stored data comprises information or at least one application, or information and at least one application.

45. A portable electronic system according to claim 40, wherein said transmitted enabling signal or enabling reply-signal comprises an identification code that is stored in the transmitting device.

46. A portable electronic system according to claim 40, wherein said device is operative to enable access to its stored data after receiving an enabling signal or an enabling reply-signal, which signal comprises an identification code that matches an identification code stored in said device.

47. A portable electronic system according to claim 45, wherein said identification code is encoded.

48. A portable electronic system according to claim 45, wherein said transmitting device is operative to encode said identification code by using a function ƒ(id, count), and said receiving device is operative to decode said received identification code by using an inverse function ƒ⁻¹(id, count), wherein “id” is the transmitted encoded identification code and “count” is a value that is continuously and synchronously updated in the transmitting and receiving devices.

49. A portable electronic system according to claim 45, wherein said identification code is stored in the device or stored in a security-unit that is adapted to be attached to the device.

50. A portable electronic system according to claim 40, wherein said second portable device is operative to control a selected subset of the operational functions of said first portable device.

51. A method for protecting the stored data in a portable electronic device or devices, said method comprising the steps of:
enabling access to the stored data of at least one of said portable electronic devices substantially the whole time an enabling signal is received by the device; and,
disabling access to the stored data of said device substantially the whole time no enabling signal is received.

52. A method according to claim 51, further comprising the steps of:
substantially continuously transmitting a request-signal within a short range from said device; and,
preparing the device for receiving an enabling reply-signal as a response to said request-signal.

53. A method according to claim 51, further comprising the step of transmitting an enabling signal within a short range from said device.

54. A method according to claim 51, further comprising the step of preparing the device for receiving a request-signal and transmitting an enabling reply-signal within a short range as a response to said request-signal.

55. A method according to claim 51, further comprising the step of enabling access to the stored data of said device after receiving an enabling signal or an enabling reply-signal, which signal comprises an identification code that matches an identification code stored in said device.

56. A method according to claim 55, wherein said identification code is encoded.

57. A method according to claim 55, further comprising the step of decoding a received identification code that is encoded by a function ƒ(id, count) by using the inverse function ƒ⁻¹(id, count), wherein “id” is the received encoded identification code and “count” is a value that is continuously and synchronously updated in the transmitting and the receiving device.
